(19) United States
(12) Patent Application Publication
(10) Pub. No.: US 2023/0055371 A1
(43) Pub. Date: Feb. 23, 2023

(54) Physical Quantity Detection Element, Physical Quantity Sensor, And Physical Quantity Sensor Device

(71) Applicant: SEIKO EPSON CORPORATION, Tokyo (JP)

(72) Inventors: Kenta SATO, Shiojiri (JP); Masayuki OTO, Okaya (JP)

(21) Appl. No.: 17/892,434

(22) Filed: Aug. 22, 2022

(30) Foreign Application Priority Data
Aug. 23, 2021 (JP) 2021-135396

(51) Int. Cl. G01P 15/08; G01P 1/02; G01P 15/097

(52) U.S. Cl. CPC G01P 15/0802; G01P 1/023; G01P 15/097; G01P 15/135

(57) ABSTRACT

A physical quantity detection element includes a first base portion and a second base portion, a pair of vibrating beams extending between the first base portion and the second base portion, and a plurality of excitation electrodes provided in surfaces of the pair of vibrating beams. The vibrating beam includes a first region, a second region, and a third region. The first region is located between the second region and the first base portion, and the third region is located between the second region and the second base portion. The excitation electrode provided in the first region is disposed such that a distance from the first base portion is 2.5% or more and 12.3% or less of a total length of the vibrating beam, and the excitation electrode provided in the third region is disposed such that a distance from the second base portion is 2.5% or more and 12.3% or less of the total length of the vibrating beam.

The present application is based on, and claims priority from JP Application Serial Number 2021-135396, filed Aug. 23, 2021, the disclosure of which is hereby incorporated by reference herein in its entirety.

### BACKGROUND

### 1. Technical Field

The present disclosure relates to a physical quantity detection element, a physical quantity sensor, and a physical quantity sensor device.

### 2. Related Art

For example, JP-A-2014-42242 discloses a double-ended tuning fork type piezoelectric vibrator element as a physical quantity detection element including excitation electrodes in an excitation region divided into three regions, and applying a voltage having a potential of an opposite polarity to adjacent excitation electrodes.

However, in the double-ended tuning fork type piezoelectric vibrator element described in JP-A-2014-42242, when the double-ended tuning fork type piezoelectric vibrator element is fixed to a cantilever or the like as the physical quantity detection element, since the excitation electrodes provided in a first region and a third region that are adjacent to base portions are adjacent to the base portions, a temperature characteristic dip may occur and a temperature characteristic correction error may deteriorate.

### SUMMARY

A physical quantity detection element includes: a first base portion and a second base portion; a pair of vibrating beams extending between the first base portion and the second base portion; and a plurality of excitation electrodes provided in surfaces of the pair of vibrating beams, respectively, in which the vibrating beam includes a first region, a second region, and a third region, the first region is located between the second region and the first base portion, and the third region is located between the second region and the second base portion. The excitation electrode provided in the first region among the plurality of excitation electrodes is disposed such that a distance from the first base portion is 2.5% or more and 12.3% or less of a total length of the vibrating beam, and the excitation electrode provided in the third region among the plurality of excitation electrodes is disposed such that a distance from the second base portion is 2.5% or more and 12.3% or less of the total length of the vibrating beam.

A physical quantity sensor includes: the physical quantity detection element described above; a cantilever configured to fix the physical quantity detection element; and a package in which the physical quantity detection element and the cantilever are housed.

A physical quantity sensor device includes: a circuit board; and three physical quantity sensors including the physical quantity sensor described above and two physical quantity sensors similar to the physical quantity sensor, in which the three physical quantity sensors are mounted on the circuit board such that respective detection axes thereof are orthogonal to one another.

### BRIEF DESCRIPTION OF THE DRAWINGS

FIG. 1 is a plan view showing a schematic structure of a physical quantity detection element according to a first embodiment.

FIG. 2 is a side view showing the schematic structure of the physical quantity detection element according to the first embodiment.

FIG. 3 is a diagram showing a temperature characteristic correction error ratio of the physical quantity detection element with respect to lengths of excitation electrodes from base portions to the excitation electrodes in a first region and a third region.

FIG. 4 is a diagram showing an oscillation limit ratio with respect to the lengths of the excitation electrodes from the base portions to the excitation electrodes in the first region and the third region.

FIG. 5 is a table showing the oscillation limit ratio from start positions to end positions of the excitation electrodes in the first region and the third region.

FIG. 6 is a diagram showing the oscillation limit ratio with respect to the length of the excitation electrode in the second region.

FIG. 7 is a cross-sectional view showing a schematic structure of a physical quantity sensor according to a second embodiment.

FIG. 8 is a perspective view showing a schematic structure of a physical quantity sensor element provided in the physical quantity sensor.

FIG. 9 is an exploded perspective view of a physical quantity sensor device according to a third embodiment.

### DESCRIPTION OF EXEMPLARY EMBODIMENTS

### 1. First Embodiment

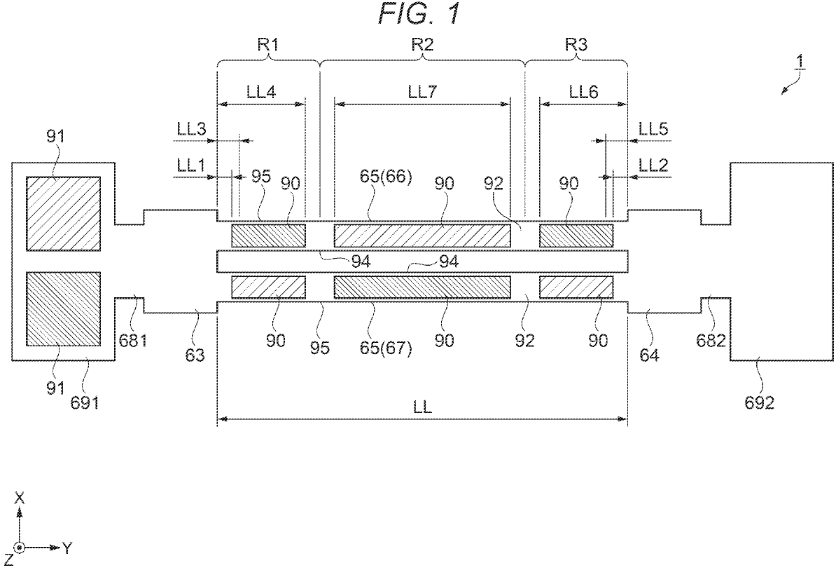

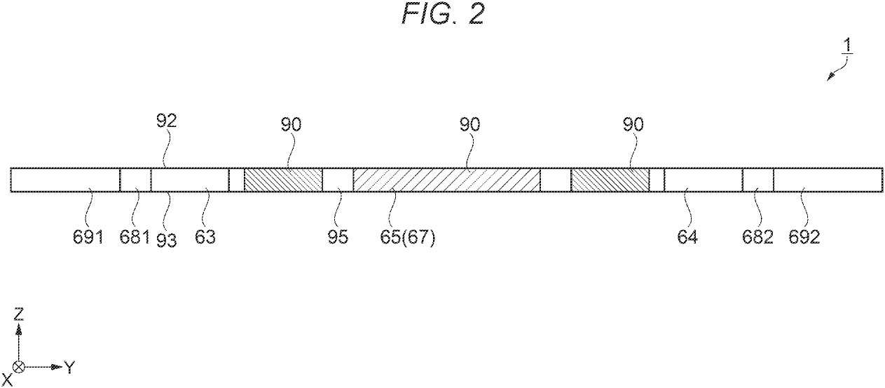

First, a physical quantity detection element 1 according to a first embodiment will be described with reference to FIGS. 1 and 2. FIGS. 1 and 2 do not show a wiring for electrically coupling each of excitation electrode 90 and a wiring for electrically coupling the excitation electrodes 90 and electrode pads 91. For convenience of description, in the following plan view, side view, cross-sectional view, and perspective view, an X axis, a Y axis, and a Z axis are shown as three axes orthogonal to one another. A direction along the X axis is referred to as an “X direction”, a direction along the Y axis is referred to as a “Y direction”, and a direction along the Z axis is referred to as a “Z direction”. An arrow side of each axis is also referred to as a “plus side”, and a side opposite to the arrow side is also referred to as a “minus side”. A plus side in the Z direction is also referred to as “upper”, and a minus side in the Z direction is also referred to as “lower”. The Z direction is along a vertical direction, and an XY plane is along a horizontal plane. In the present specification, a plus Z direction and a minus Z direction are collectively referred to as the Z direction.

The physical quantity detection element 1 is formed by, for example, a double-ended tuning fork type crystal vibrator, and detects, for example, acceleration or pressure as a physical quantity. As shown in FIGS. 1 and 2, the physical quantity detection element 1 includes a first base portion 63 and a second base portion 64, a pair of vibrating beams 65 including a plurality of excitation electrodes 90 provided on surfaces thereof and extending between the first base portion 63 and the second base portion 64, constricted portions 681 and 682, and fixed portions 691 and 692. The constricted portion 681 couples the first base portion 63 and the fixed portion 691. The constricted portion 682 couples the second base portion 64 and the fixed portion 692.

The first base portion 63 and the second base portion 64 are coupled to both ends of the pair of vibrating beams 65 in the Y direction. Lengths of the first base portion 63 and the second base portion 64 in the X direction are three times or more lengths of the vibrating beams 65 in the X direction.

The pair of vibrating beams 65 include a first vibrating beam 66 extending in the Y direction and located on a plus side in the X direction, and a second vibrating beam 67 extending in the Y direction and located on a minus side in the X direction. A thickness of the vibrating beam 65, that is, a length in the Z direction is equal to or less than 1/10 of a total length LL, which is a length of each of the vibrating beams 65 in the Y direction. Each of the vibrating beams 65 includes a first region R1, a second region R2, and a third region R3 continuously in an extending direction (Y direction) thereof. The first region R1 is located between the second region R2 located at a center of the vibrating beam 65 and the first base portion 63. The third region R3 is located between the second region R2 and the second base portion 64. The excitation electrode 90 that vibrates the vibrating beam 65 is provided on each of an upper surface 92, a lower surface 93, an inner surface 94, and an outer surface 95 of each of the first region R1, the second region R2, and the third region R3 of the first vibrating beam 66. A voltage having a potential of an opposite polarity is applied to each of the adjacent excitation electrodes 90. The excitation electrodes 90 of the second vibrating beam 67 have mirror image symmetry in a mechanical structure with respect to the excitation electrodes 90 of the first vibrating beam 66, and the voltage having the potential of the opposite polarity is applied to the corresponding excitation electrode 90.

Widths of the constricted portions 681 and 682, that is, lengths in the X direction are smaller than the lengths of the first base portion 63 and the second base portion 64 in the X direction and lengths of the fixed portions 691 and 692 in the X direction. Therefore, vibration energy of the pair of vibrating beams 65 can be prevented from being transmitted to the fixed portions 691 and 692, and distortion generated when the fixed portions 691 and 692 are fixed can be prevented from being transmitted to the vibrating beams 65.

A pair of the electrode pads 91 are provided in the upper surface 92 of the fixed portion 691 located on the minus side in the Y direction. The pair of electrode pads 91 are electrically coupled to the respective excitation electrodes 90 by the wiring (not shown). The pair of electrode pads 91 serve as an input terminal for applying a voltage for vibrating the pair of vibrating beams 65 from an outside, and also serve as an output terminal for outputting a vibration signal of the pair of vibrating beams 65 to the outside.

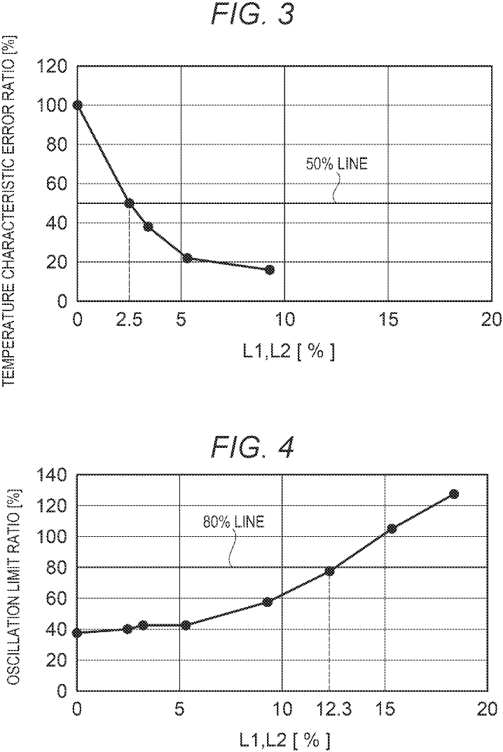

Next, each of the excitation electrodes 90 will be described in detail with reference to FIGS. 3 to 6. FIG. 3 is a diagram showing a temperature characteristic correction error ratio of the physical quantity detection element 1 with respect to L1 (L2). L1 is a ratio of a length LL1, which is a distance from the first base portion 63 to each of the excitation electrodes 90 in the first region R1, to the total length LL. L2 is a ratio of a length LL2, which is a distance from the second base portion 64 to each of the excitation electrodes 90 in the third region R3, to the total length LL. L2 is equal to L1. A temperature characteristic correction error is a maximum error between a measured value of a temperature characteristic of the physical quantity detection element 1 and an approximate curve calculated based on the measured value. The temperature characteristic correction error ratio is a value obtained by comparing the temperature characteristic correction error of the physical quantity detection element 1 when L1 and L2 are changed with reference to the temperature characteristic correction error of the physical quantity detection element 1 in which L1 and L2 are zero.

FIG. 4 is a diagram showing an oscillation limit ratio of the physical quantity detection element 1 with respect to L1 and L2. Here, the oscillation limit ratio is a value obtained by comparing a crystal impedance (CI) value of the physical quantity detection element 1 when L1 and L2 are changed with reference to a CI value of the physical quantity detection element 1 enabling oscillation. As the reference CI value, for example, an average value of the CI values enabling the oscillation can be adopted.

It can be seen from FIG. 3 that the temperature characteristic correction error ratio is 50% or less when L1 and L2 are 2.5% or more. In this case, deterioration of the temperature characteristic correction error caused by a temperature characteristic dip or the like can be reduced. A reason why one reference of the temperature characteristic correction error ratio is 50% is based on a simulation result of a vibration shape by a finite element method.

It can be seen from FIG. 4 that the oscillation limit ratio is 80% or less when L1 and L2 are 12.3% or less. In this case, the physical quantity detection element 1 having the crystal impedance (CI) value easily enabling the oscillation can be obtained. A reason why one reference of the oscillation limit ratio is 80% is that a margin such as a temperature characteristic of the CI value is taken into consideration.

Therefore, LL1 and LL2 are determined such that L1 is 2.5% or more and 12.3% or less and L2 is 2.5% or more and 12.3% or less.

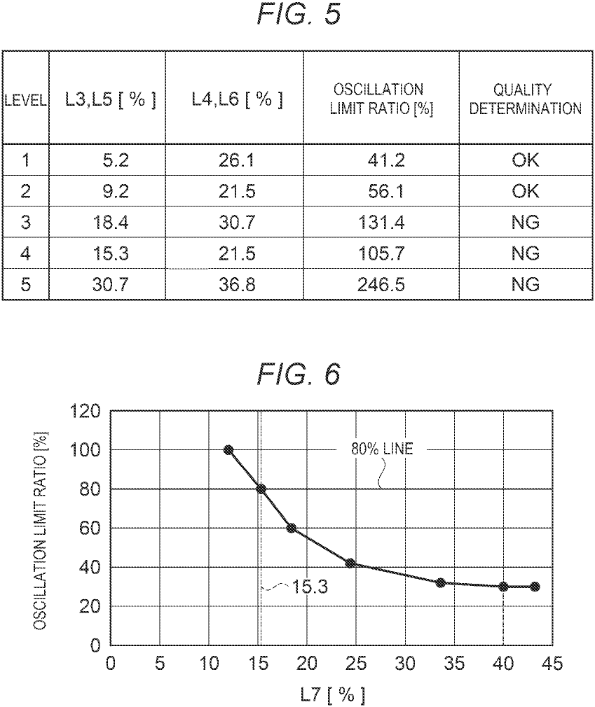

FIG. 5 is a table showing the oscillation limit ratio with respect to L3 (L5) and L4 (L6). L3 is a ratio of a length LL3, which is a distance from the first base portion 63 to a proximal end portion of each of the excitation electrodes 90 in the first region R1, to the total length LL. L5 is a ratio of a length LL5, which is a distance from the second base portion 64 to a proximal end portion of each of the excitation electrodes 90 in the third region R3, to the total length LL. L5 is equal to L3. L4 is a ratio of a length LL4, which is a distance from the first base portion 63 to a distal end portion of each of the excitation electrodes 90 in the first region R1, to the total length LL. L6 is a ratio of a length LL6, which is a distance from the second base portion 64 to a distal end portion of each of the excitation electrodes 90 in the third region R3, to the total length LL. L6 is equal to L4. Therefore, the length of each of the excitation electrodes 90 provided in the first region R1 is LL4-LL3, and the length of each of the excitation electrodes 90 provided in the third region R3 is LL6-LL5.

FIG. 5 shows results of quality determination in which the oscillation limit ratio is examined for five levels and a product is determined as a non-defective product when the oscillation limit ratio is 80% or less. The products of the level 1, in which L3 and L5 are 5.2% and L4 and L6 are 26.1%, and the level 2, in which L3 and L5 are 9.2% and L4 and L6 are 21.5%, are the non-defective products with the oscillation limit ratio of 80% or less. The products of the levels 3 to 5 are defective products because the oscillation limit ratio is larger than 80%. Therefore, even when the excitation electrodes 90 provided in the first region R1 and the third region R3 are the excitation electrodes 90 of the level 2 in which the length of the excitation electrode 90 is shorter than that of the level 1, the physical quantity detection element 1 having the crystal impedance (CI) value easily enabling the oscillation can be obtained.

Therefore, in the physical quantity detection element 1 according to the present embodiment, the excitation electrodes 90 provided in the first region R1 may be disposed so as to cover portions of 9.2% or more and 21.5% or less of the total lengths LL of the vibrating beams 65 from the first base portion 63, and the excitation electrodes 90 provided in the third region R3 may be disposed so as to cover portions of 9.2% or more and 21.5% or less of the total lengths LL of the vibrating beams 65 from the second base portion 64.

FIG. 6 is a diagram showing the oscillation limit ratio with respect to L7. L7 is a ratio of a length LL7 of each of the excitation electrodes 90 in the second region R2 in the Y direction to the total length LL of the vibrating beam 65. Centers of the vibrating beams 65 in the Y direction and centers of the excitation electrodes 90 provided in the second region R2 in the Y direction coincide with each other.

It can be seen from FIG. 6 that the oscillation limit ratio can be set to 80% or less by setting L7 to 15.3% or more. Further, when L7 is larger than 40.0%, distances between the excitation electrodes 90 in the second region R2 and the excitation electrodes 90 in the first region R1 or the third region R3 are too small. Therefore, for example, it is difficult to form a wiring electrically coupling the excitation electrodes 90 provided in the upper surface 92 and the lower surface 93 of the second region R2 to the excitation electrodes 90 provided in the inner surface 94 and the outer surface 95 of the first region R1 or the third region R3. Therefore, by setting L7 to 15.3% or more and 40.0% or less, the physical quantity detection element 1 that has the crystal impedance (CI) value easily enabling the oscillation and that is easily manufactured can be obtained.

Therefore, in the physical quantity detection element 1 according to the present embodiment, the length LL7 of each of the excitation electrodes 90 provided in the second region R2 is determined such that L7 is 15.3% or more and 40.0% or less.

As described above, in the physical quantity detection element 1 according to the present embodiment, the excitation electrodes 90 provided in the first region R1 are disposed such that the distance from the first base portion 63 is 2.5% or more and 12.3% or less of the total length LL of the vibrating beam 65. Further, the excitation electrodes 90 provided in the third region R3 are disposed such that the distance from the second base portion 64 is 2.5% or more and 12.3% or less of the total length LL of the vibrating beam 65. Therefore, the deterioration of the temperature characteristic correction error caused by the temperature characteristic dip or the like can be reduced, and the physical quantity detection element 1 having the crystal impedance (CI) value easily enabling the oscillation can be implemented.

### 2. Second Embodiment

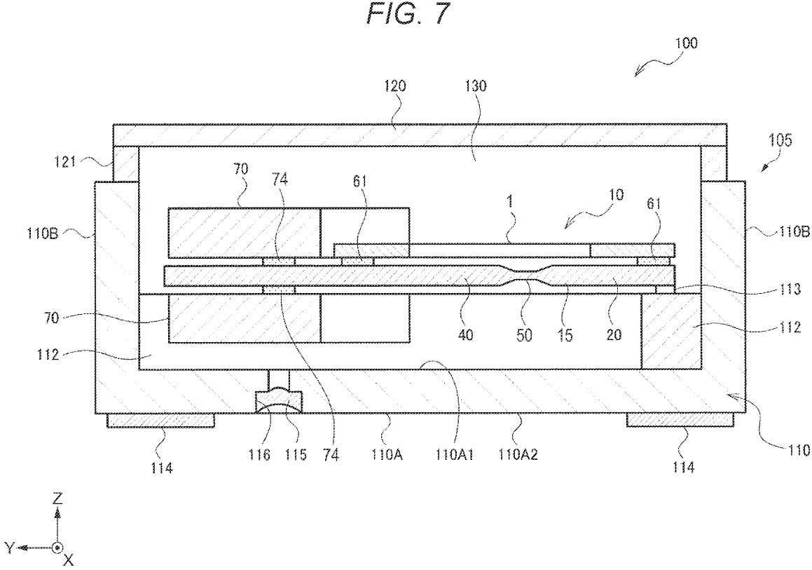

Next, a physical quantity sensor 100 according to a second embodiment will be described with reference to FIG. 7.

As shown in FIG. 7, the physical quantity sensor 100 includes a physical quantity sensor element 10 including the physical quantity detection element 1 and a cantilever 15 that fixes the physical quantity detection element 1, and a package 105 in which the physical quantity sensor element 10 is housed. The package 105 includes a base 110 on which the physical quantity sensor element 10 is mounted, and a lid 120. The lid 120 is bonded to an opening end of the base 110 via a bonding member 121 such as a glass frit or a seam ring. A physical quantity in the physical quantity sensor 100 according to the present embodiment is acceleration.

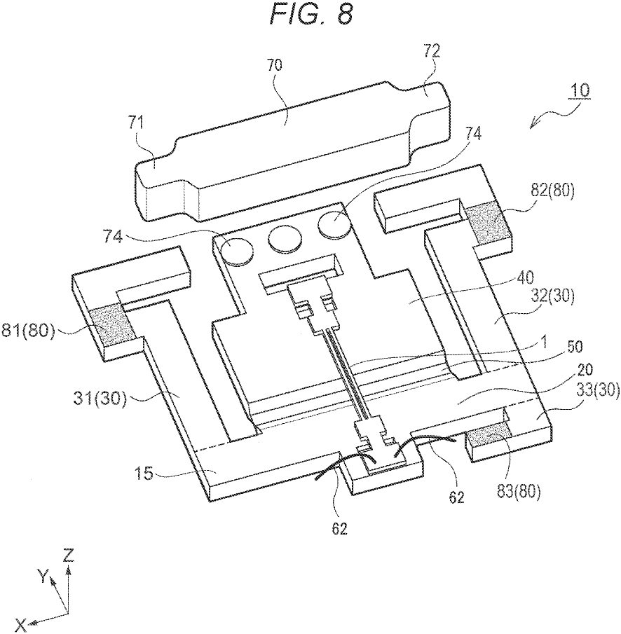

A bottom wall 110A of the base 110 is provided with a step portion 112 higher than an inner surface 110A1 of the bottom wall 110A along, for example, three side walls 110B of the four side walls 110B. The step portion 112 may protrude from inner surfaces of the side walls 110B, may be integrated with or separate from the base 110, and is a part of the base 110. As shown in FIG. 7, the physical quantity sensor element 10 is fixed to the step portion 112 with an adhesive 113. Specifically, a fixed portion 80 (see FIG. 8) of the physical quantity sensor element 10 is attached to the step portion 112 of the base 110. Here, as the adhesive 113, for example, a resin adhesive having a high elastic modulus such as an epoxy resin may be used. This is because an adhesive such as low-melting-point glass is hard and cannot absorb stress strain generated during bonding, and adversely affects the physical quantity detection element 1.

In the present embodiment, as shown in FIG. 8, the physical quantity detection element 1 can be coupled to, by bonding wires 62, an electrode such as a gold electrode provided on the step portion 112. In this case, it is not necessary to form an electrode pattern on a base portion 20 of the cantilever 15. However, the electrode pattern provided on the base portion 20 may be coupled to the electrode provided on the step portion 112 of the base 110 via a conductive adhesive without using the bonding wires 62.

An outer surface 110A2 of the bottom wall 110A of the base 110, which is a surface on a side opposite to the inner surface 110A1, is provided with external terminals 114 used when mounted on a circuit board or the like (not shown). The external terminals 114 are electrically coupled to the physical quantity detection element 1 via a wiring, an electrode, or the like (not shown).

For example, the bottom wall 110A is provided with a sealing portion 115 that hermetically seals an internal space 130 of the package 105 defined by the base 110 and the lid 120. The sealing portion 115 is provided in a through hole 116 provided in the base 110. The sealing portion 115 is provided by disposing a sealing material in the through hole 116, heating and melting the sealing material, and then solidifying the sealing material.

Next, the physical quantity sensor element 10 will be described in detail with reference to FIG. 8. The physical quantity sensor element 10 according to the present embodiment can detect acceleration in a Z direction that is a vertical direction of the physical quantity detection element 1 as a physical quantity. As shown in FIG. 8, such a physical quantity sensor element 10 includes the physical quantity detection element 1, the cantilever 15 to which the physical quantity detection element 1 is fixed, and a mass portion 70 serving as a weight.

As shown in FIG. 8, the cantilever 15 is formed of a crystal substrate, and includes the base portion 20, an arm portion 30, a movable portion 40, and a constricted portion 50. A first arm portion 31, a second arm portion 32, and a third arm portion 33 serving as the arm portion 30 are coupled to both ends of the base portion 20 in an X direction. The first arm portion 31 extending to a plus side in a Y direction is coupled to one end portion of the base portion 20, and the second arm portion 32 extending to the plus side in the Y direction and the third arm portion 33 extending to the minus side in the Y direction are coupled to the other end portion of the base portion 20.

The first arm portion 31, the second arm portion 32, and the third arm portion 33 include base portions coupled to the base portion 20, and are respectively provided with a first fixed portion 81, a second fixed portion 82, and a third fixed portion 83, which serve as the fixed portion 80, on free end portion sides.

The movable portion 40 is disposed between the first arm portion 31 and the second arm portion 32 and between the first arm portion 31 and the third arm portion 33 in a plan view from the Z direction. The constricted portion 50 is located between the base portion 20 and the movable portion 40, and couples the base portion 20 to the movable portion 40.

The physical quantity detection element 1 is disposed across the constricted portion 50 in the plan view from the Z direction, and is attached to the base portion 20 and the movable portion 40 via bonding members 61 (see FIG. 7) such as an adhesive.

The mass portion 70 is formed of, for example, a metal such as SUS or copper, and is bonded to an upper surface of the movable portion 40 on a free end portion side via bonding members 74. Further, the mass portion 70 is not limited to being bonded to an upper surface side of the movable portion 40, and may also be bonded to a lower surface side of the movable portion 40 (see FIG. 7). The mass portion 70 moves up and down together with the movable portion 40, and both end portions 71 and 72 of the mass portion 70 function as stoppers that prevent excessive amplitude by coming into contact with the first arm portion 31 and the second arm portion 32.

Here, when the movable portion 40 is displaced in accordance with a physical quantity such as acceleration or pressure with the constricted portion 50 as a fulcrum, stress is generated in the physical quantity detection element 1 attached to the base portion 20 and the movable portion 40. A resonance frequency serving as a vibration frequency of the physical quantity detection element 1 changes in accordance with the stress applied to the physical quantity detection element 1. The physical quantity can be detected based on the change in the resonance frequency.

As described above, since the physical quantity sensor 100 according to the present embodiment includes the physical quantity detection element 1 having excellent temperature characteristics, the acceleration can be detected as the physical quantity with high accuracy.

### 3. Third Embodiment

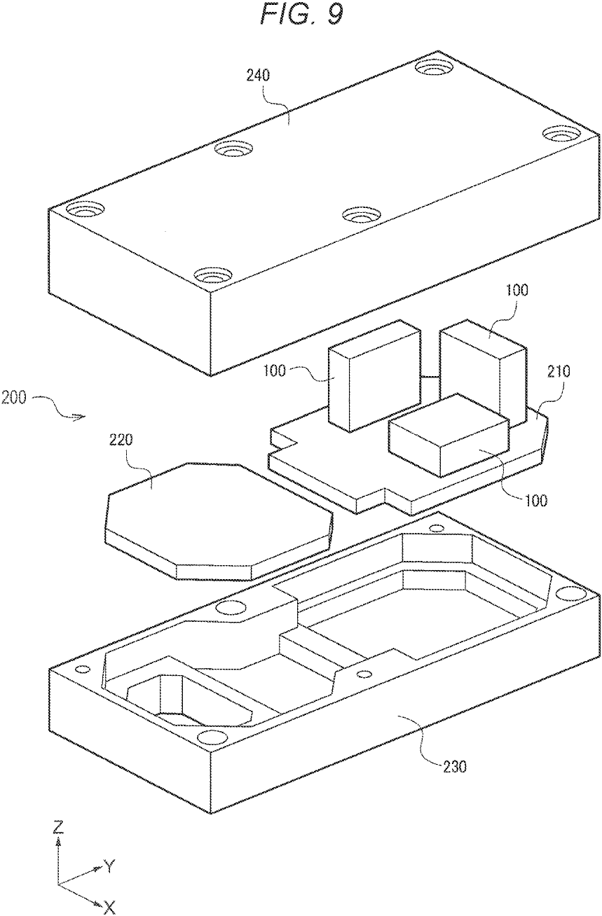

Next, a physical quantity sensor device 200 according to a third embodiment will be described with reference to FIG. 9.

The physical quantity sensor device 200 includes the three physical quantity sensors 100, and can detect a physical quantity of three axes orthogonal to one another. The physical quantity detected by the physical quantity sensors 100 in the physical quantity sensor device 200 according to the present embodiment is acceleration.

As shown in FIG. 9, in the physical quantity sensor device 200, the three physical quantity sensors 100 are mounted on a circuit board 210. The three physical quantity sensors 100 are mounted on the circuit board 210 such that detection axes of the three physical quantity sensors 100 are aligned with the three orthogonal axes. The circuit board 210 is electrically coupled to a connector board 220. The circuit board 210 and the connector board 220 are housed and held in a package formed by a package base 230 and a lid body 240.

As described above, in the physical quantity sensor device 200 according to the present embodiment, the three physical quantity sensors 100 each including the physical quantity detection element 1 having excellent temperature characteristics are mounted along the three orthogonal axes serving as the detection axes, respectively, and thus the acceleration of the three axes can be detected as the physical quantity with the high accuracy.

What is claimed is:

1. A physical quantity detection element comprising:
a first base portion and a second base portion;
a pair of vibrating beams extending between the first base portion and the second base portion; and
a plurality of excitation electrodes provided in surfaces of the pair of vibrating beams, respectively, wherein
the vibrating beam includes a first region, a second region, and a third region,
the first region is located between the second region and the first base portion, and the third region is located between the second region and the second base portion,
the excitation electrode provided in the first region among the plurality of excitation electrodes is disposed such that a distance from the first base portion is 2.5% or more and 12.3% or less of a total length of the vibrating beam, and
the excitation electrode provided in the third region among the plurality of excitation electrodes is disposed such that a distance from the second base portion is 2.5% or more and 12.3% or less of the total length of the vibrating beam.

2. The physical quantity detection element according to claim 1, wherein
the excitation electrode provided in the first region is disposed so as to cover a portion of 9.2% or more and 21.5% or less of the total length of the vibrating beam from the first base portion, and
the excitation electrode provided in the third region is disposed so as to cover a portion of 9.2% or more and 21.5% or less of the total length of the vibrating beam from the second base portion.

3. The physical quantity detection element according to claim 1, wherein
a length of the excitation electrode provided in the second region is 15.3% or more and 40.0% or less of the total length of the vibrating beam.

4. A physical quantity sensor comprising:
the physical quantity detection element according to claim 1;
a cantilever configured to fix the physical quantity detection element; and
a package in which the physical quantity detection element and the cantilever are housed.

5. A physical quantity sensor device comprising:
a circuit board; and
three physical quantity sensors including the physical quantity sensor according to claim 4 and two physical quantity sensors similar to the physical quantity sensor, wherein
the three physical quantity sensors are mounted on the circuit board such that respective detection axes thereof are orthogonal to one another.

6. The physical quantity sensor device according to claim 5, wherein
a physical quantity detected by the physical quantity sensor is acceleration.
